(19) United States
(12) Patent Application Publication
(10) Pub. No.: US 2007/0217096 A1
(43) Pub. Date: Sep. 20, 2007

(54) Integrated circuit device

(76) Inventors: Kenichi Ishida, Kanagawa (JP); Yosikazu Nishikawa, Kanagawa (JP); Eiji Nagata, Kanagawa (JP)

Correspondence Address: MCDERMOTT WILL & EMERY LLP, 600 13TH STREET, NW, WASHINGTON, DC, 20005-3096, US

(21) Appl. No.: 11/714,269

(22) Filed: Mar. 6, 2007

(30) Foreign Application Priority Data
Mar. 6, 2006 (JP) P.2006-060023

(51) Int. Cl. H02H 7/00

(52) U.S. Cl. 361/18

(57) ABSTRACT

In an integrated circuit apparatus made up of three or more integrated circuits which are supplied with power from three or more power supply sources that can be subjected to individually-controllable shutoff and which are sequentially subjected to interruption of power supply, control of a power shutoff circuit inserted into a signal line between integrated circuits is facilitated without regard to the physical layout of integrated circuits.

A power shutoff control signal is imparted to a power shutoff circuit which is inserted into a signal line for interconnecting integrated circuits and which controls an output from a power shutoff circuit to a fixed state during shutoff of power to a connection-target integrated circuit. Accordingly, the integrated circuits are selected in sequence of interruption of power supply. The power shutoff circuit is inserted to a position close to an integrated circuit which becomes later in sequence of interruption of power as compared with the selected integrated circuit or a position close to an integrated circuit whose power is not shut off. A power shutoff control circuit 2 for imparting a power shutoff control signal to the inserted power shutoff circuit is formed in a dispersed manner at a position close to the integrated circuit that becomes later in sequence of power shutoff as compared with the selected integrated circuit or at a position close to an integrated circuit whose power is not shut off.

### BACKGROUND OF THE INVENTION

1. Field of the Invention

The present invention relates to an integrated circuit device for use with multiple power sources.

2. Description of the Related Art

A request for a larger-scale, lower-power system LSI has recently been growing more and more. In association with an increase in the scale of the system LSI, the system LSI has become equipped with a plurality of functional blocks, and the power consumption of the system LSI exhibits an increasing tendency. Accordingly, there is adopted a method for reducing power consumption by means of shutting off the power to inoperative functional blocks. At that time, in order to avoid occurrence of a problem, which would otherwise arise when power-shutoff blocks are connected to non-power-shutoff blocks, the following power shutoff circuit insertion method as described in Patent Document 1 is adopted in the related art. In most instances, when the power to specific functional blocks is shut off, a power shutoff circuit for fixing the logical status of an input signal at the time of shutoff of the power is inserted into a signal line between functional blocks whose power is not to be shut off and functional blocks whose power is to be shut off, with a view toward preventing occurrence of a leakage current.

FIG. 12 is a view showing a related-art power shutoff circuit inserted between integrated circuits whose power is to be shut off and an integrated circuit whose power is not to be shut off, all of the circuits being included in a system LSI. In FIG. 12, reference numeral 1201 designates an integrated circuit whose power is not to be shut off; 1202 designates an integrated circuit whose power is to be shut off; 1203 designates a power selection circuit; 1205 designates a power shutoff circuit inserted into a signal line extending from the integrated circuit 1202 whose power is to be shut off toward the integrated circuit 1201 whose power is not to be shut off; and 1206 designates a power shutoff control register.

A terminal B of the power shutoff circuit 1205 is for a power shutoff control signal; a terminal A of the same is for an input signal; and a terminal Y of the same is for an output signal. The power shutoff control register 1206 is fixed to L or H before the power to the integrated circuit 1202 is shut off. An output of the power shutoff control register 1206 is connected to the terminal B of the power shutoff circuit 1205, and the power shutoff control register 1206 controls the power shutoff state and the conduction state of the power shutoff circuit 1205.

In a case where the power shutoff circuit 1205 is not provided, when the signal line—extending from the integrated circuit 1202 whose power is to be shut off toward the integrated circuit 1201 whose power is not to be shut off—has become unstable, a gate potential of a CMOS transistor in an input circuit of the integrated circuit 1201 connected to this signal line becomes unstable, whereby a PMOS transistor and an NMOS transistor are brought into a state of electrical conduction, to thus generate a leakage current.

In the related art, when the power selection circuit 1203 supplies the power to both the integrated circuit 1201 and the integrated circuit 1202, an input signal A and an output signal Y, which belong to the power shutoff circuit 1205, are brought into electrical conduction by means of fixing the power shutoff control register 1206 to the state of electrical conduction. When the supply of the power to the integrated circuit 1202 is shut off, the power shutoff control register 1206 is fixed to a power shutoff state before entering the power shutoff state, whereby the power shutoff circuit 1205 is controlled so as to enter a power shutoff state, thereby preventing occurrence of a leakage current, which would otherwise be induced as a result of the signal line extending from the integrated circuit 1202 toward the integrated circuit 1201 becoming unstable.

[Patent Document 1] JP-A-2005-33637 (FIGS. 4 and 10)

However, the above related-art technique is for fixing the operation of the power shutoff circuit by means of the power shutoff control register placed in the integrated circuit which is supplied with the power at all times. Hence, when the system LSI is split into a plurality of power supplies numbering more than three and has a plurality of power shutoff states, power shutoff control must be performed in an integrated circuit which is constantly supplied with the power to the end without involvement of interruption of the power. When an integrated circuit constantly supplied with the power is separated a great distance from another integrated circuit in terms of physical layout, there arises a problem of difficulty being encountered in controlling a power shutoff circuit inserted between the integrated circuits.

### SUMMARY OF THE INVENTION

The present invention aims at facilitating control of a power shutoff circuit inserted into a signal line between integrated circuits without regard to the physical layout of integrated circuits even when a plurality of integrated circuits constituting a system LSI are divided by means of a plurality of power supplies of three or more power sources and have a plurality of power shutoff states.

The present invention provides an integrated circuit apparatus made up of three or more integrated circuits which are supplied with power from three or more power supply sources that can be subjected to individually-controllable shutoff and which are sequentially subjected to interruption of power supply, the apparatus comprising:

a power shutoff circuit inserted into a signal line for connecting the integrated circuits at a position close to an integrated circuit which becomes later in sequence of undergoing power shutoff as compared with the integrated circuits selected in sequence in which power supply is interrupted or at a position close to an integrated circuit whose power is not shut off;

a power shutoff control circuit which imparts a power shutoff control signal to the power shutoff circuit such that an output from the power shutoff circuit is controlled so as to enter a fixed state at the time of shutoff of power of the target connection integrated circuit, wherein the power shutoff control circuit is formed in a dispersed manner at a position close to the integrated circuit which becomes later in sequence of being subjected to power shutoff as compared with the integrated circuits selected in sequence in which power supply is interrupted or at a position close to an integrated circuit whose power is not shut off.

According to the above configuration, when power to a certain integrated circuit is shut off, a power shutoff circuit to be connected to the integrated circuit is inserted to a position close to an integrated circuit which becomes later in sequence of power shutoff as compared with the integrated circuit or a position close to an integrated circuit which is not subjected to power shutoff. A power shutoff control circuit which imparts a power shutoff control signal to the power shutoff circuit is formed in a dispersed manner to a position close to an integrated circuit which becomes later in sequence of power shutoff than the integrated circuit or a position close to an integrated circuit whose power is not shut off. This power shutoff control circuit is formed in an appropriately-dispersed manner according to the physical layout of integrated circuits. As a result, control of the power shutoff circuit inserted into a signal line connected between integrated circuits can be facilitated.

In the present invention, the power shutoff control circuit is formed on an integrated circuit into which the power shutoff circuit is inserted. According to this configuration, the power shutoff control circuit which imparts a power shutoff control signal to the power shutoff circuit is formed on an integrated circuit to which the power shutoff circuit is to be inserted. Influence of physical layout of the integrated circuits on the control of the power shutoff circuit inserted into the signal line between the integrated circuits can be minimized.

In the present invention, the power shutoff control circuit is formed on an integrated circuit whose power is not shut off. The power shutoff control signal is imparted to the power shutoff circuit via the integrated circuit into which the power shutoff circuit is inserted. By means of this configuration, the power shutoff control circuit that imparts a power shutoff control signal to the power shutoff circuit is formed on the integrated circuit whose power is not interrupted. The power shutoff control signal is imparted to the power shutoff circuit via the integrated circuit into which the power shutoff circuit is inserted. Hence, influence of physical layout of the integrated circuits on the control of the power shutoff circuit inserted into the signal line between the integrated circuits can be minimized.

In the present invention, the power supply source is formed from one external supply source and a plurality of internally-provided power switches.

According to the present invention, the power shutoff control circuit that imparts a power shutoff control signal to the power shutoff circuit is formed on an integrated circuit into which the power shutoff circuit is inserted or on the integrated circuit whose power is not shut off. The power shutoff control signal is imparted to the power shutoff circuit by way of the integrated circuit into which the power shutoff circuit is inserted. Hence, influence of physical layout of the integrated circuits on the control of the power shutoff circuit inserted into the signal line between the integrated circuits can be minimized. As a result, even in an integrated circuit supplied with multiple power sources, lessening of a leakage current which arises at the time of power shutoff can be realized in all power shutoff states.

### BRIEF DESCRIPTION OF THE DRAWINGS

FIG. 1 is a drawing showing the configuration of an integrated circuit device of the present invention;

FIG. 2 is a view showing the configuration of the integrated circuit device of the present invention;

FIG. 3 is a view showing the configuration of the integrated circuit device of the present invention;

FIG. 4 is a view showing the configuration of the integrated circuit device of the present invention;

FIG. 5 is a view showing the configuration of the integrated circuit device of the present invention;

FIG. 6 is a view showing the configuration of the integrated circuit device of the present invention;

FIGS. 7A to 7F are circuit diagrams showing a plurality of example configurations of a power shutoff circuit;

FIG. 8 is a flowchart showing processing procedures of a power shutoff control circuit insertion method;

FIG. 9 is a block diagram showing a general configuration of a power shutoff control circuit insertion device for implementing the power shutoff control circuit insertion method and pieces of information input to and output from the power shutoff control circuit insertion device;

FIG. 10 is a flowchart showing verification procedures of the power shutoff control circuit insertion method;

FIG. 11 is a block diagram showing the general configuration of a power shutoff control circuit verification device for implementing the verification procedures of the power shutoff control circuit insertion method and information input and output by the device; and

FIG. 12 is a view showing the configuration of a related-art integrated circuit device using a power shutoff circuit and a power shutoff control circuit.

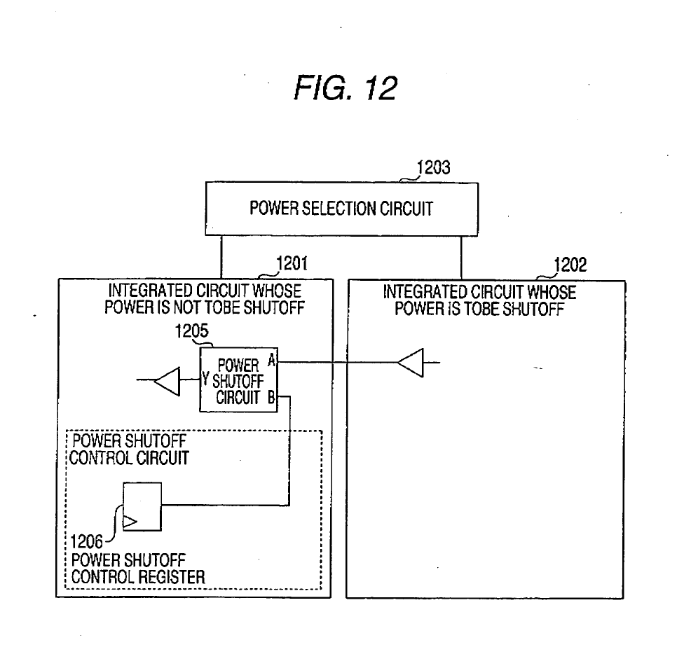

### DETAILED DESCRIPTION OF THE PREFERRED EMBODIMENTS

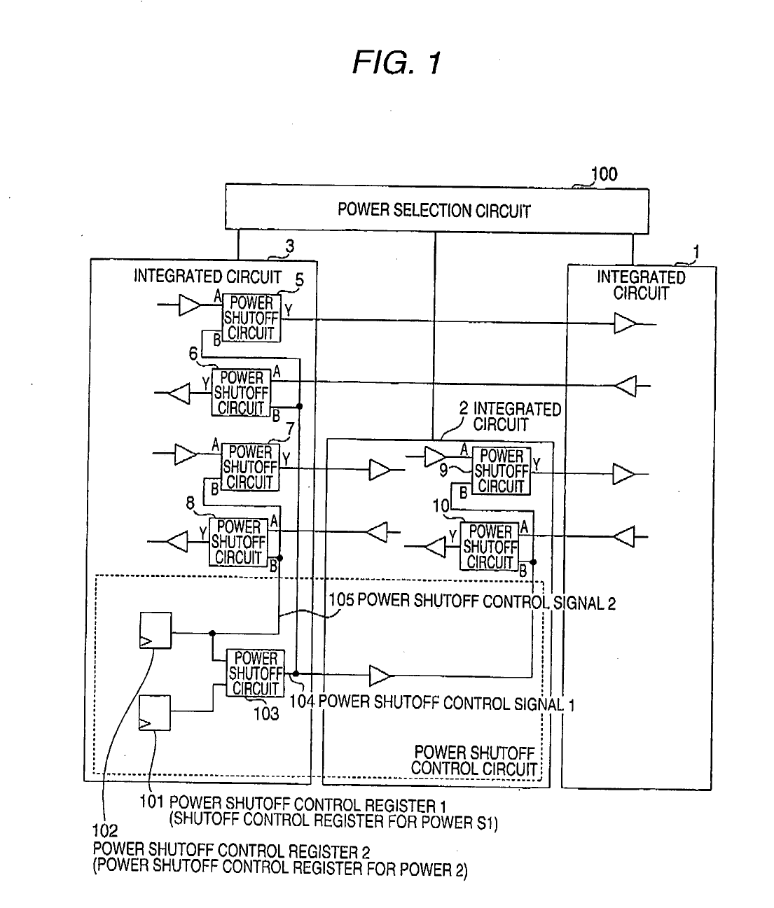

FIG. 1 is a view showing an integrated circuit device of one embodiment of the present invention. In FIG. 1, reference numerals 1 through 3 designate integrated circuits; reference numerals 5 through 10 designate power shutoff circuits; 100 designates a power selection circuit for feeding or shutting off power 1, power 2, and power 3 to the integrated circuit 1, the integrated circuit 2, and the integrated circuit 3, respectively; 101 designates a power shutoff control register 1 for controlling shutoff of power 1; 102 designates a power shutoff control register 2 for controlling shutoff of power 2; 103 designates a power shutoff control register for controlling shutoff of power; 104 designates a power shutoff control signal 1 for power 1; and 105 designates a power shutoff control signal 2 for power 2.

The power selection circuit 100 is equipped with a plurality of power switches and feed or shut off three types of power (power 1, power 2, and power 3) for the integrated circuit 1, the integrated circuit 2, and the integrated circuit 3. A state where power to all of the integrated circuits is not shut off is taken as a power-supplied state 1; a state where the power to the integrated circuit 1 is shut off is taken as a power-supplied state 2; and a state where the power to the integrated circuit 1 and the power to the integrated circuit 2 are sequentially shut off is taken as a power-supplied state 3.

Before shutoff of power 1 and power 2, the power shutoff control register 1 and the power shutoff control register 2 are fixed to an L or H state, and control the power shutoff state and electrical conduction state of power 1 and those of power 2, respectively. Specifically, before the power to the integrated circuit 1 is shut off in the power-supplied state 2 and the power-supplied state 3, the power shutoff control register 1 is fixed to a power shutoff state. Before the power to the integrated circuit 2 is shut off in the power-supplied state 3, the power shutoff control register 2 is fixed to the power shutoff state.

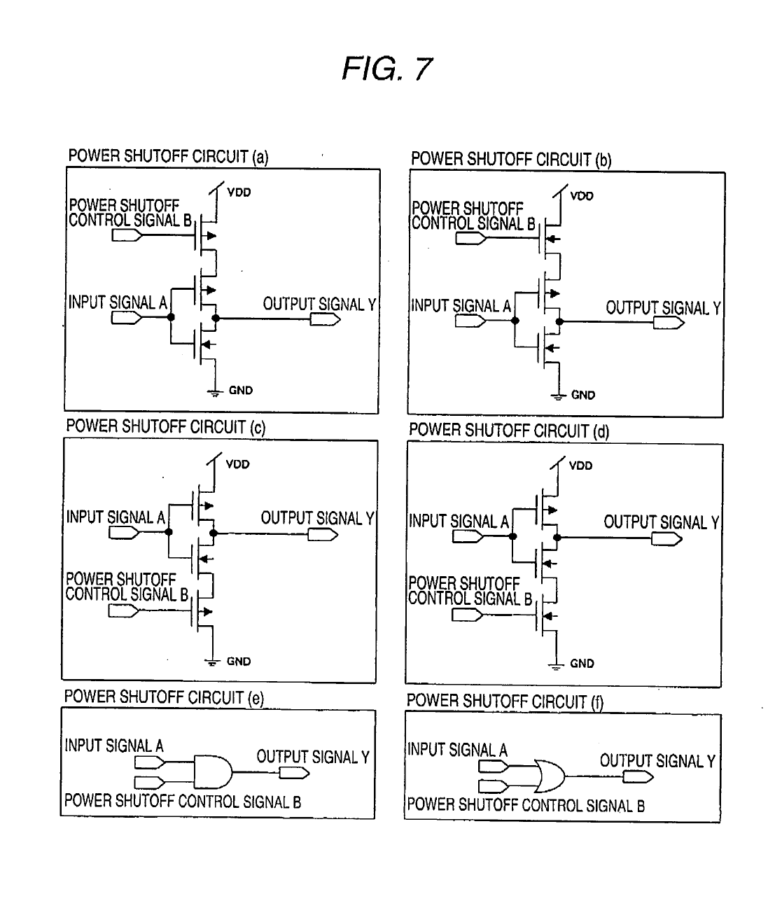

When being inserted into an input signal line originating from the integrated circuit whose power has been shut off, the power shutoff circuit prevents occurrence of a leakage current in an input circuit and fixes an output value to an expected value of the system configuration. Further, when being inserted into an output signal line extending to the integrated circuit whose power has been shut off, an output value is fixed so as not to generate a toggle, in order to lessen a burden on the integrated circuit whose power has been shut off. FIG. 7 provides circuit diagrams showing a plurality of example configurations of the power shutoff circuit, and circuits of the diagrams can be taken as power shutoff circuits 5 to 10. In these power shutoff circuits, reference symbol A designates an input signal; B designates a power shutoff control signal; and Y designates an output signal.

In the power shutoff circuit shown in FIG. 7A, a PMOS transistor connected to the power shutoff control signal B is activated in normal times as a result of the power shutoff control signal B being brought into an L state. During power shutoff, the input signal A is electrically connected to the output signal Y, to thus bring the power shutoff control signal B into an H state, whereby the PMOS transistor connected to the power shutoff control signal B is deactivated and occurrence of a leakage current is prevented. As a result, the output signal Y is fixed to the L state.

In the power shutoff circuit shown in FIG. 7B, an NMOS transistor connected to the power shutoff control signal B is activated in normal times as a result of the power shutoff control signal B being brought into the H state. During power shutoff, the input signal A is electrically connected to the output signal Y, to thus bring the power shutoff control signal B into the L state, whereby the NMOS transistor connected to the power shutoff control signal B is deactivated and occurrence of a leakage current is prevented. As a result, the output signal Y is fixed to the L state.

In the power shutoff circuit shown in FIG. 7C, the PMOS transistor connected to the power shutoff control signal B is activated in normal times as a result of the power shutoff control signal B being brought into the L state. During power shutoff, the input signal A is electrically connected to the output signal Y, to thus bring the power shutoff control signal B into the H state, whereby the PMOS transistor connected to the power shutoff control signal B is deactivated and occurrence of a leakage current is prevented. As a result, the output signal Y is fixed to the H state.

In the power shutoff circuit shown in FIG. 7D, the NMOS transistor connected to the power shutoff control signal B is activated in normal times as a result of the power shutoff control signal B being brought into the H state. During power shutoff, the input signal A is electrically connected to the output signal Y, to thus bring the power shutoff control signal B into the L state, whereby the NMOS transistor connected to the power shutoff control signal B is deactivated and occurrence of a leakage current is prevented. As a result, the output signal Y is fixed to the H state.

The power shutoff circuit shown in FIG. 7E is constituted of an AND circuit, and the power shutoff control signal B is brought into the H state in normal times, to thus electrically connect the input signal A to the output signal Y. During power shutoff, the power shutoff control signal B is fixed to the L state, and the output signal Y is fixed to the L state.

The power shutoff circuit shown in FIG. 7F is constituted of an OR circuit, and the power shutoff control signal B is brought into the L state in normal times, thereby electrically connecting the input signal A to the output signal Y. During power shut off, the power shutoff control signal B is fixed to the H state, thereby fixing the output signal Y to the H state.

In the example configuration of the system LSI shown in FIG. 1, the power shutoff circuit 10 is placed at a position close to the integrated circuit 2 along the signal line extending from the integrated circuit 1 to the integrated circuit 2, and the power shutoff circuit 9 is placed at a position close to the integrated circuit 2 along the signal line extending from the integrated circuit 2 to the integrated circuit 1. Likewise, the power shutoff circuit 6 is placed at a position close to the integrated circuit 3 along the signal line extending from the integrated circuit 1 to the integrated circuit 3, and the power shutoff circuit 5 is placed at a position close to the integrated circuit 3 along the signal line extending from the integrated circuit 3 to the integrated circuit 1. Likewise, the power shutoff circuit 8 is placed at a position close to the integrated circuit 3 along the signal line extending from the integrated circuit 2 to the integrated circuit 3, and the power shutoff circuit 7 is placed at a position close to the integrated circuit 3 along the signal line extending from the integrated circuit 3 to the integrated circuit 2.

The power shutoff control register 1, the power shutoff control register 2, and the power shutoff circuit 103 are placed in the integrated circuit 3 whose power is not shut off to the end. A signal output from the power shutoff control register 1 and a signal output from the power shutoff control register 2 are input to the power shutoff circuit 103. An output from the power shutoff circuit 103 turns into the power shutoff control signal 1, and the signal output from the power shutoff control register 2 turns into the power shutoff control signal 2.

The power shutoff control signal 1 is connected to each of the power shutoff control signal B of the power shutoff circuit 5, that of the power shutoff circuit 6, that of the power shutoff circuit 9, and that of the power shutoff circuit 10, and these power shutoff circuits are fixed to a power shutoff state in the power-supplied state 2. The power shutoff control signal 2 is connected to the power shutoff control signal B of the power shutoff circuit 7 and that of the power shutoff circuit 8, and these power shutoff circuits are fixed to the power shutoff state in the power-supplied state 3.

In the power-supplied state 1, power to all of the integrated circuits is not shut off by the power shutoff control circuit configured as mentioned above. The power shutoff control register 1 and the power shutoff control register 2 are fixed to an electrically-connected state, and the power shutoff control signal 1 and the power shutoff control signal 2 are also fixed to an electrically-connected state. The signals A input to the respective power shutoff circuits are electrically connected, in unmodified form, to the respective output signals Y.

In the power-supplied state 2, the power shutoff control register 1 is fixed to a power shutoff state before the integrated circuit 1 shuts off power, and the power shutoff control signal 1 is fixed to a power shutoff state by way of the power shutoff circuit 103. The power shutoff control signal 1 brings the power shutoff control signals B of the power shutoff circuits 6 and 10 into a power shutoff state, to thus prevent occurrence of a leakage current, and the output values of the shutoff circuits 6 and 10 are fixed. Likewise, output values of the power shutoff circuits 5 and 9 are also fixed.

In power-supplied state 3, the power shutoff control register 2 is fixed to a power shutoff state subsequent to the operation in the power-supplied state 2 and before shutoff of power to the integrated circuit 2. The power shutoff control signal 2 is also fixed to a power shutoff state. The power shutoff control signal 2 fixes the power shutoff control signal B of the power shutoff circuit 8 to the power shutoff state, to thus prevent occurrence of a leakage current, and an output value of the power shutoff circuit 8 is fixed. Likewise, an output value of the power shutoff circuit 7 is also fixed.

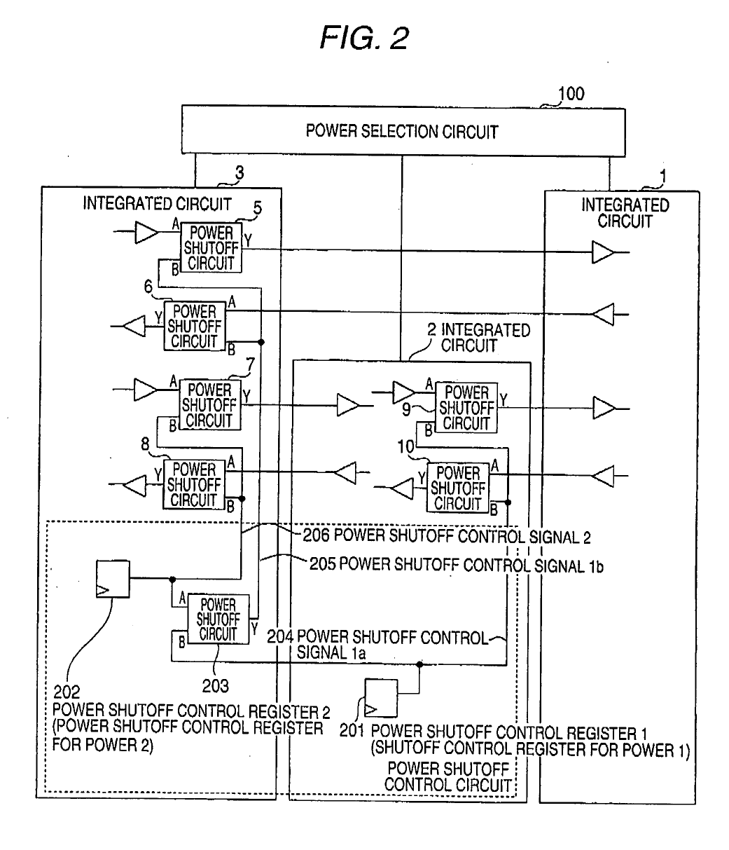

FIG. 2 is a view showing the configuration of an integrated circuit apparatus according to another embodiment of the present invention. In FIG. 2, circuits denoted by the same reference numerals as used in FIG. 1 are identical with those shown in FIG. 1, and connections of the circuits are also the same as those shown in FIG. 1.

The power selection circuit 100 supplies or shuts off three types of power (power 1, power 2, and power 3) to the integrated circuit 1, the integrated circuit 2, and the integrated circuit 3. The integrated circuit apparatus of the present embodiment is also identical with the integrated circuit apparatus shown in FIG. 1 in that a state where power to all of the integrated circuits is not shut off is taken as a power-supplied state 1, a case where power to the integrated circuit 1 is shut off is taken as a power-supplied state 2, and a case where power to the integrated circuit 1 and power to the integrated circuit 2 are sequentially shut off is taken as a power-supplied state 3.

In FIG. 2, reference numeral 201 designates a power shutoff control register 1 for controlling shutoff of power 1; 202 designates a power shutoff control register 2 for controlling shutoff of power 2; 203 designates a power shutoff circuit for use with a power shutoff control signal; 204 designates a power shutoff control signal 1a of power 1; 205 designates a power shutoff control signal 1b of power 1; and 206 designates a power shutoff control signal 2 of power 2. The functions of these power shutoff control registers and the functions of the power shutoff circuit are identical with those of the integrated circuit apparatus shown in FIG. 1.

In the present embodiment, the power shutoff control register 1 is placed in the integrated circuit 2, and the power shutoff control register 2 and the power shutoff circuit 203 are provided in the integrated circuit 3 whose power is not shut off to the end. The signal output from the power shutoff control register 1 turns into the power shutoff control signal 1a; and a signal output from the power shutoff control register 1 and a signal output from the power shutoff control register 2 are input to the power shutoff circuit 203. An output from the power shutoff circuit 203 turns into the power shutoff control signal 1b, and a signal output from the power shutoff control register 2 turns into the power shutoff control signal 2. By means of this configuration, even when the power shutoff control signal 1a has become unstable in the power-supplied state 3, the power shutoff control signal 1b is fixed by means of the power shutoff circuit 203.

The power shutoff control signal 1a is connected to each of the power shutoff control signals B of the power shutoff circuits 9 and 10, and in the power-supplied state 2 these power shutoff circuits are fixed to a power shutoff state. The power shutoff control signal 1b is connected to each of the power shutoff control signals B of the power shutoff circuits 5 and 6, and in the power supply state 2 these power shutoff circuits are fixed to a power shutoff state. The power shutoff control signal 2 is connected to each of the power shutoff control signals B of the power shutoff circuits 7 and 8, and in the power-supplied state 3 these power shutoff circuits are fixed to a power shutoff state.

In the power-supplied state 1, none of these integrated circuits is subjected to power shutoff, by virtue of the above-configured power shutoff control circuit. Hence, the power shutoff control register 1 and the power shutoff control register 2 are fixed to an electrically-connected state, and the power shutoff control signal 1a, the power shutoff control signal 1b, and the power shutoff control signal 2 are also fixed to an electrically-connected state. The signals A input to the respective power shutoff circuits are electrically connected, in unmodified form, to the output signal Y.

In the power-supplied state 2, before power to the integrated circuit 1 is shut off, the power shutoff control register 1 is fixed to a power shutoff state; the power shutoff control signal 1a is fixed to a power shutoff state; and the power shutoff control signal 1b is fixed to a power shutoff state by way of the power shutoff circuit 203. The power shutoff control signal 1a brings the power shutoff control signal B of the power shutoff circuit 10 into a power shutoff state, and the power shutoff control signal 1b brings the power shutoff control signal B of the power shutoff circuit 6 into a power shutoff state, thereby preventing occurrence of a leakage current, and output values of these power shutoff circuits are fixed. Likewise, an output value of the power shutoff circuit 5 and an output value of the power shutoff circuit 9 are fixed.

In the power-supplied state 3, the power shutoff control register 2 is fixed to the power shutoff state subsequent to operation in the power-supplied state 2 and before shutoff of power to the integrated circuit 2, and the power shutoff control signal 2 is also fixed to a power shutoff state. The power shutoff control signal 2 fixes the power shutoff control signal B of the power shutoff circuit 8 to a power-shut state, to thus prevent occurrence of a leakage current; and an output value of the power shutoff circuit 8 is fixed. Likewise, an output value of the power shutoff circuit 7 is also fixed.

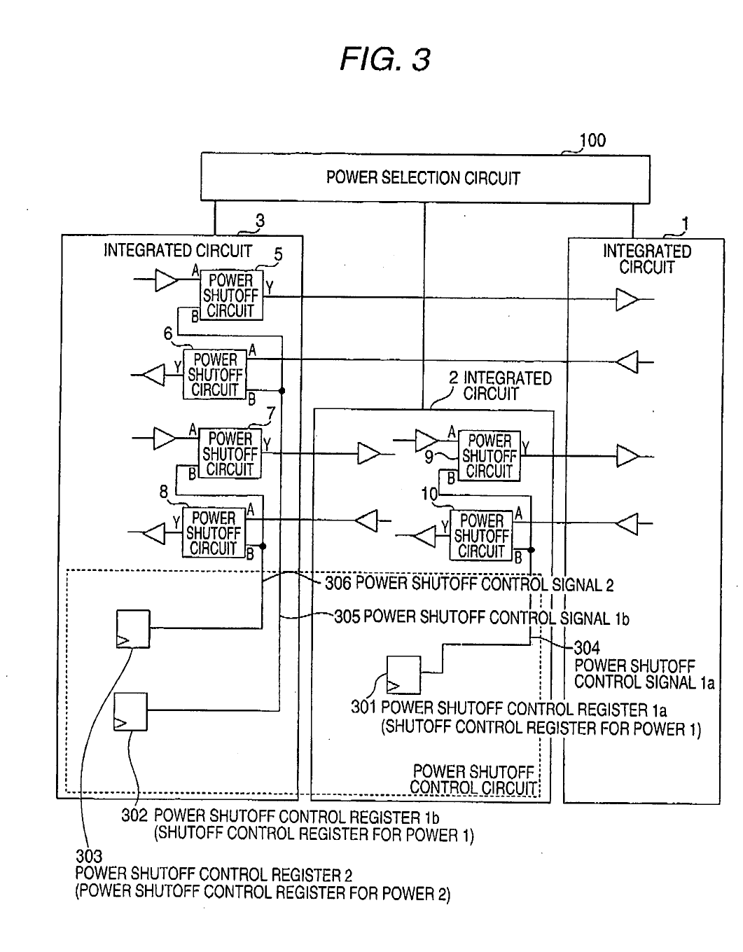

FIG. 3 shows the configuration of an integrated circuit apparatus of yet another embodiment. In FIG. 3, those circuits which are denoted by the same reference numeral as those shown in FIG. 1 are identified with the corresponding circuits of FIG. 1, and connections of the circuits are also the same as those shown in FIG. 1.

The power selection circuit 100 supplies or shuts off three types of power (power 1, power 2, and power 3) to the integrated circuit 1, the integrated circuit 2, and the integrated circuit 3. The integrated circuit apparatus of the present embodiment is also identical with the integrated circuit apparatus shown in FIG. 1, in that a state where power to all of the integrated circuits is not shut off is taken as a power-supplied state 1, a case where power to the integrated circuit 1 is shut off is taken as a power-supplied state 2, and a case where power to the integrated circuit 1 and power to the integrated circuit 2 are sequentially shut off is taken as a power-supplied state 3.

In FIG. 3, reference numerals 301 and 302 designate power shutoff control registers 1a and 1b for controlling shutoff of power 1; 303 designates a power shutoff control register 2 for controlling shutoff of power 2; 304 designates the power shutoff control signal 1a of power 1; 305 designates the power shutoff control signal 1b of power 1; and 306 designates a power shutoff control signal 2 of power 2. The functions of these power shutoff control registers are identical with those of the integrated circuit apparatus shown in FIG. 1.

In the present embodiment, the power shutoff control register 1a is placed in the integrated circuit 2, and the power shutoff control register 1b and the power shutoff control register 2 are provided in the integrated circuit 3 whose power is not shut off to the end. The signal output from the power shutoff control register 1a turns into the power shutoff control signal 1a; a signal output from the power shutoff control register 1b turns into a power shutoff control signal 1b; and a signal output from the power shutoff register 2 turns into the power shutoff control signal 2. By means of this configuration, even when the power shutoff control signal 1a has become unstable in the power-supplied state 3, the power shutoff control signal 1b is fixed.

The power shutoff control signal 1a is connected to each of the power shutoff control signals B of the power shutoff circuits 9 and 10, and in the power-supplied state 2 these power shutoff circuits are fixed to a power shutoff state. The power shutoff control signal 1b is connected to each of the power shutoff control signals B of the power shutoff circuits 5 and 6, and in the power supply state 2 these power shutoff circuits are fixed to a power shutoff state. The power shutoff control signal 2 is connected to each of the power shutoff control signals B of the power shutoff circuits 7 and 8, and these power shutoff circuits are fixed to a power shutoff state by means of the power-supplied state 3.

In the power-supplied state 1, none of these integrated circuits is subjected to power shutoff, by virtue of the above-configured power shutoff control circuit. Hence, the power shutoff control register 1a, the power shutoff control register 1b, and the power shutoff control register 2 are fixed to an electrically-connected state, and the power shutoff control signal 1a, the power shutoff control signal 1b, and the power shutoff control signal 2 are also fixed to an electrically-connected state. The signals A input to the respective power shutoff circuits are electrically connected, in unmodified form, to the output signal Y.

In the power-supplied state 2, before power to the integrated circuit 1 is shut off, the power shutoff control registers 1a and 1b are fixed to a power shutoff state, and the power shutoff control signals 1 and 1b are fixed to the power shutoff state, as well. The power shutoff control signal 1a brings the power shutoff control signal B of the power shutoff circuit 10 into a power shutoff state, and the power shutoff control signal 1b brings the power shutoff control signal B of the power shutoff circuit 6 into a power shutoff state, thereby preventing occurrence of a leakage current, and output values of these power shutoff circuits are fixed. Likewise, an output value of the power shutoff circuit 5 and an output value of the power shutoff circuit 9 are fixed.

In the power-supplied state 3, the power shutoff control register 2 is fixed to the power shutoff state subsequent to operation in the power-supplied state 2 and before shutoff of power to the integrated circuit 2, and the power shutoff control signal 2 is also fixed to a power shutoff state. The power shutoff control signal 2 fixes the power shutoff control signal B of the power shutoff circuit 8 to a power-shut state, and an output value of the power shutoff circuit 8 is fixed. Likewise, an output value of the power shutoff circuit 7 is also fixed.

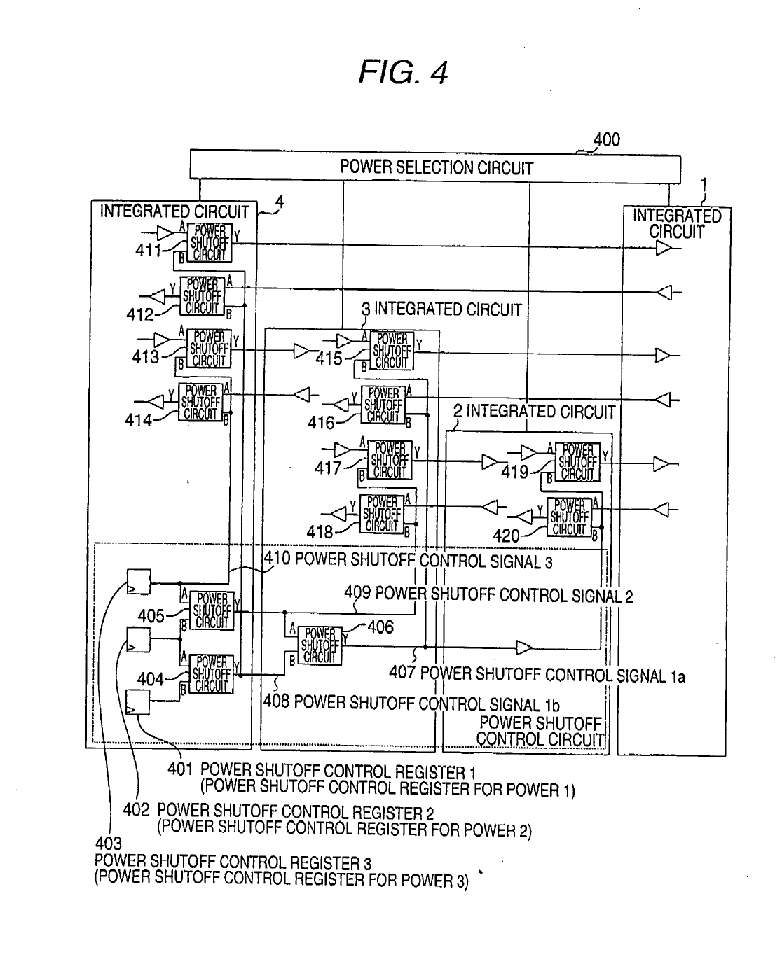

FIG. 4 shows the configuration of an integrated circuit apparatus of still another embodiment. In FIG. 4, reference numerals 1 through 4 designate integrated circuits; reference numerals 5 through 14 designate power shutoff circuits; 400 designates a power selection circuit for supplying or shutting off power 1, power 2, power 3, and power 4 to the integrated circuit 1, the integrated circuit 2, the integrated circuit 3, and the integrated circuit 4; 401 designates a power shutoff control register 1 for controlling shutoff of power 1; 402 designates a power shutoff control register 2 for controlling shutoff of power 2; 403 designates a power shutoff control register 3 for controlling shutoff of power 3; reference numerals 404 to 406 designate power shutoff circuits for use with a power shutoff control signal; 407 designates a power shutoff control signal 1a of power 1; 408 designates a power shutoff control signal 1b of power 1; 409 designates a power shutoff control signal 2 of power 2; and 410 designates a power shutoff control signal 3 of power 3. The functions of these circuits are identical with those of corresponding circuits shown in FIG. 1.

The power selection circuit 400 is provided with a plurality of power switches and supplies or shuts off four, types of power (power 1, power 2, power 3, and power 4) to the integrated circuit 1, the integrated circuit 2, the integrated circuit 3, and the integrated circuit 4. A state where power to all of the integrated circuits is not shut off is taken as a power-supplied state 1, a case where power to the integrated circuit 1 is shut off is taken as a power-supplied state 2, a case where power to the integrated circuit 1 and power to the integrated circuit 2 are sequentially shut off is taken as a power-supplied state 3, and a state where power to the integrated circuit 1, power to the integrated circuit 2, and power to the integrated circuit 3 are sequentially shut off is taken as a power-supplied state 4.

The power shutoff control register 1 is fixed to an L or H state before shutoff of power 1, thereby controlling a power shutoff state and a conduction state of power 1; the power shutoff control register 2 is fixed to an L or H state before shutoff of power 2, thereby controlling a power shutoff state and a conduction state of power 2; and the power shutoff control register 3 is fixed to an L or H state before shutoff of power 3, thereby controlling a power shutoff state and a conduction state of power 3. Specifically, the power shutoff control register 1 is fixed to the power shutoff state before power to the integrated circuit 1 is shut off in the power-supplied states 2, 3, and 4. The power shutoff control register 2 is fixed to the power shutoff state before power to the integrated circuit 2 is shut off in the power-supplied states 3 and 4. The power shutoff control register 3 is fixed to the power shutoff state before power to the integrated circuit 3 is shut off in the power-supplied state 4.

In this embodiment, the layout of the power shutoff circuits 5 through 10 in the integrated circuits 1 through 3 is the same as the first example configuration shown in FIG. 1. Moreover, the power shutoff circuit 12 is placed at a position close to the integrated circuit 4 along the signal line extending from the integrated circuit 1 to the integrated circuit 4, and the power shutoff circuit 11 is placed at a position close to the integrated circuit 4 along the signal line extending from the integrated circuit 4 to the integrated circuit 1. Likewise, the power shutoff circuit 14 is placed at a position close to the integrated circuit 4 along the signal line extending from the integrated circuit 3 to the integrated circuit 4, and the power shutoff circuit 13 is placed at a position close to the integrated circuit 4 along the signal line extending from the integrated circuit 4 to the integrated circuit 3.

The power shutoff control register 1 the power shutoff control register 2, the power shutoff control register 3, and the power shutoff circuits 404 and 405 are placed in the integrated circuit 4 whose power is not shutoff to the end; and the power shutoff circuit 406 is placed in the integrated circuit 3. A signal output from the power shutoff control register 3 turns into the power shutoff control signal 3, and the signal output from the power shutoff control register 3 and the signal output from the power shutoff control register 2 are input to the power shutoff circuit 405. A signal output from the power shutoff circuit 405 turns into the power shutoff control signal 2. The signal output from the power shutoff control register 2 and the signal output from the power shutoff control register 1 are input to the power shutoff circuit 404, and an output from the power shutoff circuit 404 turns into the power shutoff control signal 1b. The power shutoff control signal 2 and the power shutoff control signal 1b are input to the power shutoff circuit 406; and the output from the power shutoff circuit 406 turns into the power shutoff control signal 1a. By means of this configuration, even when power shutoff control signal 1a has become unstable in the power-supplied state 4, the power shutoff control signal 1b is fixed by means of the power shutoff circuit 404.

The power shutoff control signal 1a is connected to each of the power shutoff control signal B of the power shutoff circuit 5, that of the power shutoff circuit 6, that of the power shutoff circuit 9, and that of the power shutoff circuit 10; and these power shutoff circuits are fixed to a power shutoff state in the power-supplied state 2. The power shutoff control signal 1b is connected to the power shutoff control signal B of the power shutoff circuit 11 and that of the power shutoff circuit 12; and these power shutoff circuits are fixed to the power shutoff state in the power-supplied state 2. The power shutoff control signal 2 is connected to the power shutoff control signal B of the power shutoff circuit 7 and that of the power shutoff circuit 8; and these power shutoff circuits are fixed to the power shutoff state in the power-supplied state 3. The power shutoff control signal 3 is connected to the power shutoff control signal B of the power shutoff circuit 13 and that of the power shutoff circuit 14; and these power shutoff circuits are fixed to the power shutoff state in the power-supplied state 4.

In the power-supplied state 1, power to all of the integrated circuits is not shut off by the power shutoff control circuit configured as mentioned above. Hence, the power shutoff control register 1, the power shutoff control register 2, and the power shutoff control register 3 are fixed to an electrically-connected state; and the power shutoff control signal 1a, the power shutoff control signal 1b, the power shutoff control signal 2, and the power shutoff control signal 3 are also fixed to an electrically-connected state. The signals A input to the respective power shutoff circuits are electrically connected, in unmodified form, to the respective output signals Y.

In the power-supplied state 2, the power shutoff control register 1 is fixed to a power shutoff state before power to the integrated circuit 1 is shut off, and the power shutoff control signal 1a and the power shutoff control signal 1b are fixed to a power shutoff state, as well. The power shutoff control signal 1a brings the power shutoff control signals B of the power shutoff circuits 6 and 10 into a power shutoff state, to thus prevent occurrence of a leakage current, and the output values of the shutoff circuits 6 and 10 are fixed. The power shutoff control signal 1b brings the power shutoff control signal B of the power shutoff circuit 12 into a power shutoff state, thereby preventing occurrence of a leakage current, and an output value of the circuit is fixed. Likewise, output values of the power shutoff circuits 5, 9, and 11 are fixed.

In power-supplied state 3, the power shutoff control register 2 is fixed to a power shutoff state subsequent to the operation in the power-supplied state 2 and before shutoff of power to the integrated circuit 2. The power shutoff control signal 2 is also fixed to a power shutoff state. The power shutoff control signal 2 fixes the power shutoff control signal B of the power shutoff circuit 8 to the power shutoff state, to thus prevent occurrence of a leakage current, and an output value of the power shutoff circuit 8 is fixed. Likewise, an output value of the power shutoff circuit 7 is also fixed.

In power-supplied state 4, the power shutoff control register 3 is fixed to a power shutoff state subsequent to the operation in the power-supplied state 3 and before shutoff of power to the integrated circuit 3. The power shutoff control signal 3 is also fixed to a power shutoff state. The power shutoff control signal 3 fixes the power shutoff control signal B of the power shutoff circuit 14 to the power shutoff state, to thus prevent occurrence of a leakage current, and an output value of the power shutoff circuit 14 is fixed. Likewise, an output value of the power shutoff circuit 13 is also fixed.

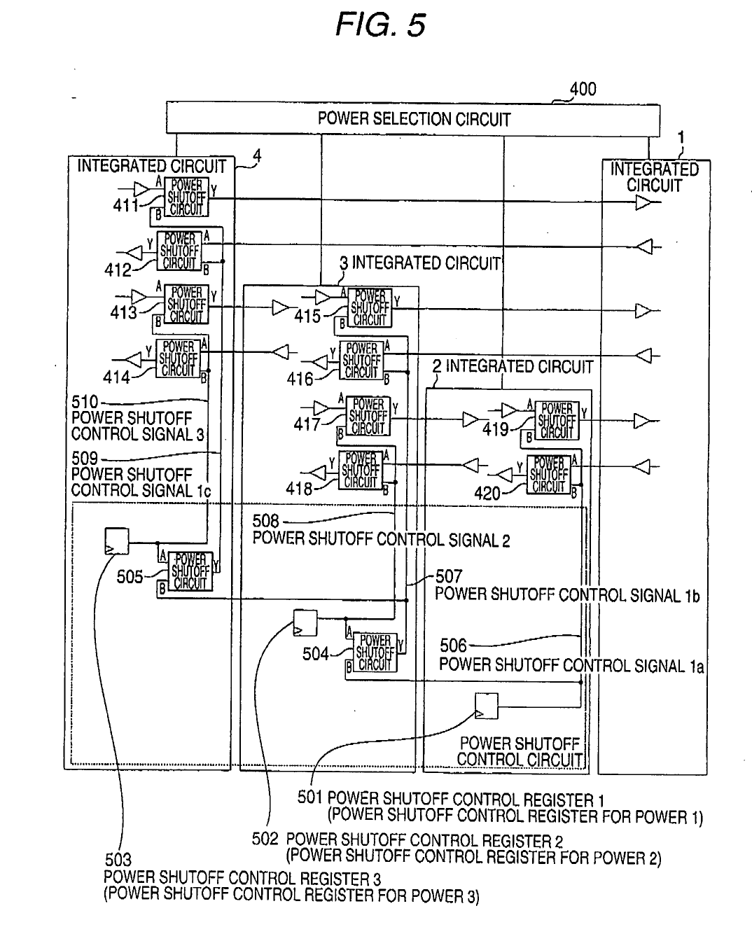

FIG. 5 shows the configuration of an integrated circuit apparatus of still another embodiment. In FIG. 5, those circuits denoted by the same reference numerals as in FIG. 4 are identical with corresponding circuits of FIG. 4, and connections of the circuits are also the same as those shown in FIG. 4.

The power selection circuit 400 supplies or shuts off four types of power (power 1, power 2, power 3, and power 4) to the integrated circuit 1, the integrated circuit 2, the integrated circuit 3, and the integrated circuit 4. The integrated circuit apparatus of the present embodiment is also identical with the fourth example configuration in that a state where power to all of the integrated circuits is not shut off is taken as a power-supplied state 1, a case where power to the integrated circuit 1 is shut off is taken as a power-supplied state 2, a case where power to the integrated circuit 1 and power to the integrated circuit 2 are sequentially shut off is taken as a power-supplied state 3, and a case where power to the integrated circuit 1, power to the integrated circuit 2, and power to the integrated circuit 3 are sequentially shut off is taken as a power-supplied state 4.

In FIG. 5, reference numeral 501 designates a power shutoff control register 1 for controlling shutoff of power 1; 502 designates a power shutoff control register 2 for controlling shutoff of power 2; 503 designates a power shutoff control register 2 for controlling shutoff of power 3; 504 and 505 designate power shutoff circuits for use with a power shutoff control signal; 506, 507, and 509 designate the power shutoff control signal 1a, the power shutoff control signal 1b, and the power shutoff control signal 1c of power 1; 508 designates the power shutoff control signal 2 of power 2; and 510 designates the power shutoff control signal 3 of power 3. The function of the power shutoff control register and the function of the power shutoff circuit are identical with those of the integrated circuit apparatus shown in FIG. 1.

In the present embodiment, the power shutoff control register 1 is placed in the integrated circuit 2: the power shutoff control register 2 and the power shutoff circuit 504 are provided in the integrated circuit 3; and the power shutoff control register 3 and the power shutoff circuit 505 are placed in the integrated circuit 4. A signal output from the power shutoff control register 1 turns into the power shutoff control signal 1a; a signal output from the power shutoff control register 2 turns into the power shutoff control signal 2; and a signal output from the power shutoff register 3 turns into the power shutoff control signal 3. The power shutoff control signal 1a and the signal output from the power shutoff control register 2 are input to the power shutoff circuit 504; and the output from the power shutoff circuit 504 turns into the power shutoff control signal 1b. The power shutoff control signal 1b and the signal output from the power shutoff control register 3 are input to the power shutoff circuit 505; and the output from the power shutoff circuit 505 turns into the power shutoff control signal 1c. By means of this configuration, even when power shutoff control signal 1a has become unstable in the power-supplied state 3, the power shutoff control signal 1b is fixed by means of the power shutoff circuit 504. Even when power shutoff control signal 1b has become unstable in the power-supplied state 4, the power shutoff control signal 1c is fixed by means of the power shutoff circuit 505.

In the power-supplied state 1, power to all of the integrated circuits is not shut off by the power shutoff control circuit configured as mentioned above. Hence, the power shutoff control register 1, the power shutoff control register 2, and the power shutoff control register 3 are fixed to an electrically-connected state; and the power shutoff control signal 1a, the power shutoff control signal 1b, the power shutoff control signal 1c, the power shutoff control signal 2, and the power shutoff control signal 3 are also fixed to an electrically-connected state. The signals A input to the respective power shutoff circuits are electrically connected, in unmodified form, to the respective output signals Y.

In the power-supplied state 2, the power shutoff control register 1 is fixed to a power shutoff state before power to the integrated circuit 1 is shut off; and the power shutoff control signal 1a, the power shutoff control signal 1b, and the power shutoff control signal 1c are fixed to a power shutoff state, as well. The power shutoff control signal 1a brings the power shutoff control signals B of the power shutoff circuit 10 into a power shutoff state, to thus prevent occurrence of a leakage current, and the output value of the shutoff circuit 10 is fixed. The power shutoff control signal 1b brings the power shutoff control signal B of the power shutoff circuit 6 into a power shutoff state, thereby preventing occurrence of a leakage current, and an output value of the circuit 6 is fixed. The power shutoff control signal 1c brings the power shutoff control signal B of the power shutoff circuit 12 into a power shutoff state, thereby preventing occurrence of a leakage current, and an output value of the circuit 12 is fixed. Likewise, output values of the power shutoff circuits 5, 9, and 11 are fixed.

In power-supplied state 3, the power shutoff control register 2 is fixed to a power shutoff state subsequent to the operation in the power-supplied state 2 and before shutoff of power to the integrated circuit 2. The power shutoff control signal 2 is also fixed to a power shutoff state. The power shutoff control signal 2 fixes the power shutoff control signal B of the power shutoff circuit 8 to the power shutoff state, to thus prevent occurrence of a leakage current, and an output value of the power shutoff circuit 8 is fixed. Likewise, an output value of the power shutoff circuit 7 is also fixed.

In power-supplied state 4, the power shutoff control register 3 is fixed to a power shutoff state subsequent to the operation in the power-supplied state 3 and before shutoff of power to the integrated circuit 3. The power shutoff control signal 3 is also fixed to a power shutoff state. The power shutoff control signal 3 fixes the power shutoff control signal B of the power shutoff circuit 14 to the power shutoff state, to thus prevent occurrence of a leakage current, and an output value of the power shutoff circuit 14 is fixed. Likewise, an output value of the power shutoff circuit 13 is also fixed.

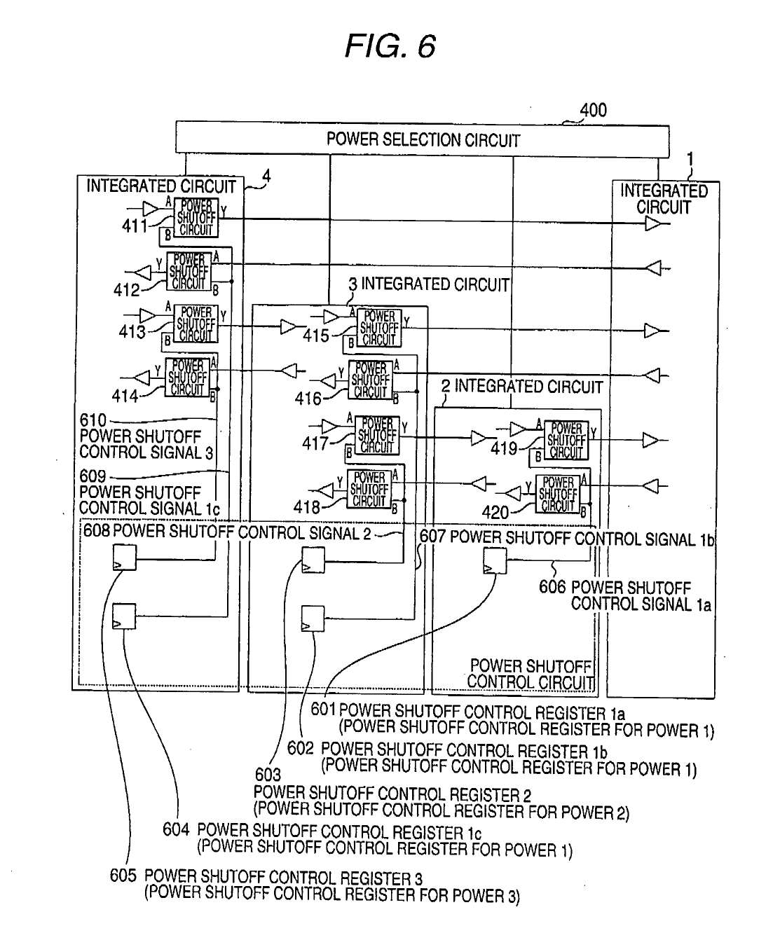

FIG. 6 shows the configuration of an integrated circuit apparatus of yet another embodiment. In FIG. 6, those circuits which are denoted by the same reference numerals as in FIG. 4 are identical with corresponding circuits of FIG. 4, and connections of the circuits are also the same as those shown in FIG. 4.

The power selection circuit 400 supplies or shuts off four types of power (power 1, power 2, power 3, and power 4) to the integrated circuit 1, the integrated circuit 2, the integrated circuit 3, and the integrated circuit 4. The integrated circuit apparatus of the present embodiment is also identical with the integrated circuit apparatus shown in FIG. 4 in that a state where power to all of the integrated circuits is not shut off is taken as a power-supplied state 1, a case where power to the integrated circuit 1 is shut off is taken as a power-supplied state 2, a case where power to the integrated circuit 1 and power to the integrated circuit 2 are sequentially shut off is taken as a power-supplied state 3, and a case where power to the integrated circuit 1, power to the integrated circuit 2, and power to the integrated circuit 3 are sequentially shut off is taken as a power-supplied state 4.

In FIG. 6, reference numeral 601 designates a power shutoff control register 1a for controlling shutoff of power 1; 602 designates a power shutoff control register 1b for controlling shutoff of power 1; 604 designates a power shutoff control register 1c for controlling shutoff of power 1; 603 designates a power shutoff control register 2 for controlling shut of power 2; 605 designates a power shutoff control register 3 for controlling shut of power 3; 606, 607, and 609 designate the power shutoff control signal 1a, the power shutoff control signal 1b, and the power shutoff control signal 1c of power 1; 608 designates the power shutoff control signal 2 of power 2; 610 designates the power shutoff control signal 3 of power 3. The functions of these power shutoff control registers are identical with those of the integrated circuit apparatus shown in FIG. 1.

In the present embodiment, the power shutoff control register 1a is placed in the integrated circuit 2; the power shutoff control register 1b and the power shutoff control register 2 are provided in the integrated circuit 3; and the power shutoff control register 1c and the power shutoff control register 3 are placed in the integrated circuit 4. A signal output from the power shutoff control register 1a turns into the power shutoff control signal 1a; a signal output from the power shutoff control register 1b turns into a power shutoff control signal 1b; a signal output from the power shutoff register 1c turns into the power shutoff control signal 1c; a signal output from the power shutoff control register 2 turns into the power shutoff control signal 2; and a signal output from the power shutoff control register 3 turns into the power shutoff control signal 3.

In the power-supplied state 1, power to all of the integrated circuits is not shut off by the power shutoff control circuit configured as mentioned above. Hence, the power shutoff control register 1a, the power shutoff control register 1b, the power shutoff control register 1c, the power shutoff control register 2, and the power shutoff control register 3 are fixed to an electrically-connected state; and the power shutoff control signal 1a, the power shutoff control signal 1b, the power shutoff control signal 1c, the power shutoff control signal 2, and the power shutoff control signal 3 are also fixed to an electrically-connected state. The signals A input to the respective power shutoff circuits are electrically connected, in unmodified form, to the respective output signals Y.

In the power-supplied state 2, the power shutoff control register 1a, the power shutoff control register 1b, and the power shutoff control register 1c are fixed to a power shutoff state before power to the integrated circuit 1 is shut off; and the power shutoff control signal 1a, the power shutoff control signal 1b, and the power shutoff control signal 1c are fixed to a power shutoff state, as well. The power shutoff control signal 1a brings the power shutoff control signals B of the power shutoff circuit 10 into a power shutoff state, to thus prevent occurrence of a leakage current, and the output value of the shutoff circuit 10 is fixed. The power shutoff control signal 1b brings the power shutoff control signal B of the power shutoff circuit 6 into a power shutoff state, thereby preventing occurrence of a leakage current, and an output value of the circuit 6 is fixed. The power shutoff control signal 1c brings the power shutoff control signal B of the power shutoff circuit 12 into a power shutoff state, thereby preventing occurrence of a leakage current, and an output value of the circuit 12 is fixed. Likewise, output values of the power shutoff circuits 5, 9, and 11 are fixed.

In power-supplied state 3, the power shutoff control register 2 is fixed to a power shutoff state subsequent to the operation in the power-supplied state 2 and before shutoff of power to the integrated circuit 2. The power shutoff control signal 2 is also fixed to a power shutoff state. The power shutoff control signal 2 fixes the power shutoff control signal B of the power shutoff circuit 8 to the power shutoff state, to thus prevent occurrence of a leakage current, and an output value of the power shutoff circuit 8 is fixed. Likewise, an output value of the power shutoff circuit 7 is also fixed.

In power-supplied state 4, the power shutoff control register 3 is fixed to a power shutoff state subsequent to the operation in the power-supplied state 3 and before shutoff of power to the integrated circuit 3. The power shutoff control signal 3 is also fixed to a power shutoff state. The power shutoff control signal 3 fixes the power shutoff control signal B of the power shutoff circuit 14 to the power shutoff state, to thus prevent occurrence of a leakage current, and an output value of the power shutoff circuit 14 is fixed. Likewise, an output value of the power shutoff circuit 13 is also fixed.

Thus, the cases where three power supplies are shut off have been described as the integrated circuit apparatus of the present invention by reference to FIGS. 1 through 3; and the cases where four power supplies are shut off have been described as the integrated circuit apparatus of the present invention by reference to FIGS. 4 through 6. Needless to say, the present invention can be applied to integrated circuits which are formed in a single silicon substrate and controls power shutoff, regardless of the number of integrated circuits or the type of power.

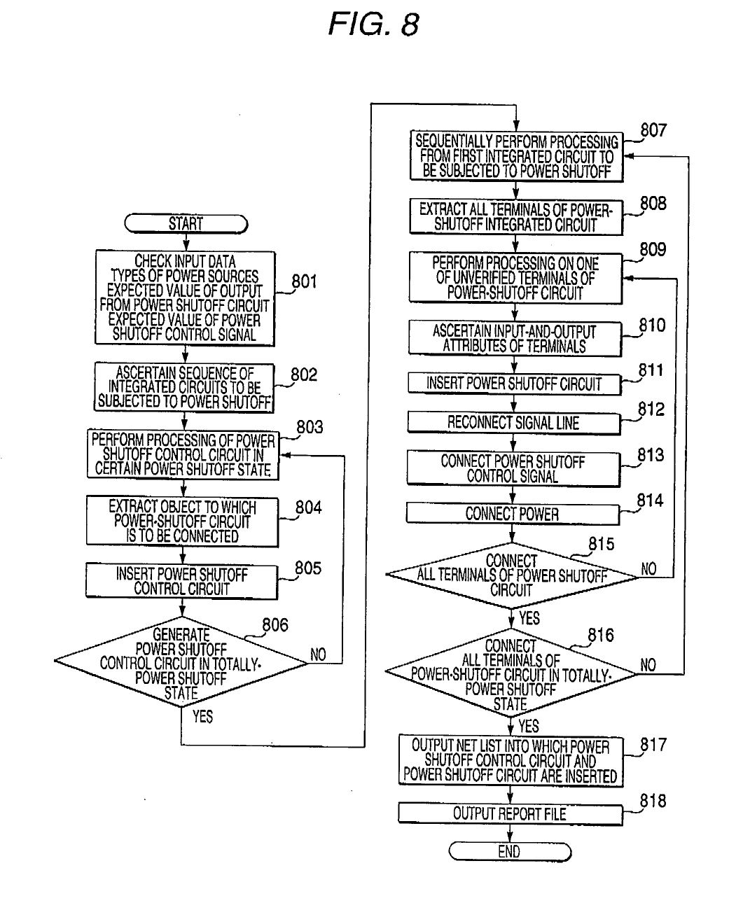

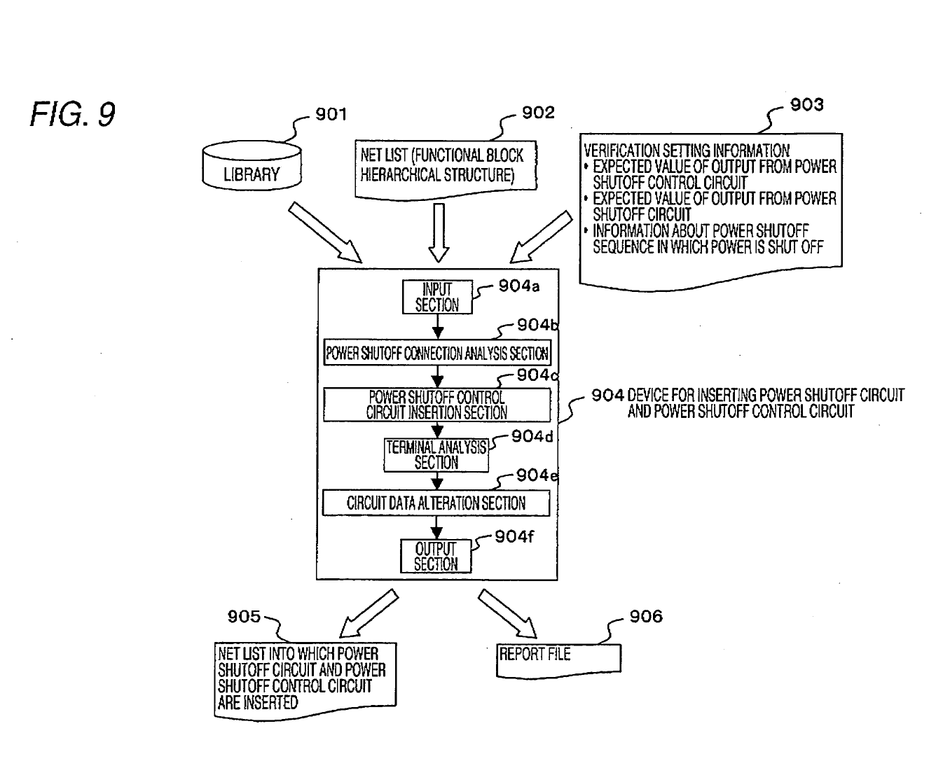

Processing procedures of the power shutoff control circuit insertion method will now be described. FIG. 8 is a flowchart showing processing procedures of the power shutoff control circuit insertion method, and FIG. 9 is a block diagram showing the general configuration of a power shutoff control circuit insertion apparatus implementing processing procedures of the power shutoff control circuit insertion method and information about inputs and outputs to and from the apparatus.

In FIG. 9, reference numeral 904 designates a power shutoff control circuit insertion apparatus. Reference numeral 901 designates a library including circuit configuration data pertaining to a power shutoff circuit; 902 designates a net list having a functional block hierarchical structure; and 903 designates insertion setting information, all of which are pieces information input to the apparatus. Reference numeral 905 designates a power shutoff circuit and a net list into which the power shutoff control circuit has already been inserted; and 906 designates a report file in which a result of implementation of insertion processing, and they are taken as output information.

The insertion setting information 903 includes power shutoff sequence information about integrated circuits whose power is to be shut off; information about integrated circuits whose power is to be shut off; information about terminals of the integrated circuits; information about a target integrated circuit to which connection is to be made; an expected output value of the power shutoff circuit achieved during power shutoff; an expected output value out from the power shutoff control circuit during power shutoff; and an expected value of the power shutoff control signal generated by the power shutoff control circuit during power shutoff.

In the power shutoff control circuit insertion device 904, reference numeral 904a designates an input section by way of which the library 901, the net list 902, and insertion setting information 903 are input and stored; 904b designates a power shutoff connection analysis section which extracts information about an integrated circuit whose power is to be shut off and an integrated circuit—to which connection is to be made (hereinafter called a “connection-target integrated circuit”)—and which stores the extracted information; 904c designates a power shutoff control circuit insertion section for inserting a power shutoff control circuit such as that indicated by the first through eighth example configurations; 904d designates a terminal analysis section for analyzing input-and-output attributes of terminals of the integrated circuit whose power is to be shut off and input-and-output attributes of terminals of the connection-target integrated circuit; 904e designates a circuit data alteration section which inserts the power shutoff circuit such as that shown in FIG. 7 into a signal line to which the integrated circuit is to be connected, to thus effect terminal wiring and which makes a connection with a power shutoff control signal generated by the power shutoff control circuit, to thus alter circuit data; and 904f designates an output section for outputting the report file 906 having descriptions of alterations and the net list 905 into which the power shutoff circuit and the power shutoff control circuit have already been inserted.

Next, a method for inserting a power shutoff circuit and a power shutoff control circuit, which is performed by the power shutoff control circuit insertion device 904, is described by reference to the flowchart shown in FIG. 8.

Processing pertaining to [CHECK INPUT DATA] step 801 is performed by the input section 904a. There are input types of power supplied to the respective integrated circuits, information about a sequence of shutting off power, an expected output value of a power shutoff circuit to be inserted, an expected value of a power shutoff control signal generated by the power shutoff control circuit, and a net list and a library of each of the integrated circuits. An inspection is made as to whether or not these sets of data have a data configuration which poses no problem in processing for inserting the power shutoff circuit and the power shutoff control circuit. These sets of data are stored.

Processing pertaining to [CHECK SEQUENCE OF INTEGRATED CIRCUITS BEING SUBJECTED TO POWER SHUTOFF] step 802 is performed by the input section 904a. Patterns of a power shutoff state are registered on the basis of information about a sequence of integrated circuits being subjected to power shutoff stored in Step 801.

Processing pertaining to [PERFORM PROCESSING OF CERTAIN POWER SHUTOFF CONTROL CIRCUIT IN POWER SHUTOFF STATE] step 803 is performed by the power shutoff connection analysis section 904b. The patterns of the power shutoff state registered in step 802 are sequentially selected, to thus prepare for insertion of a power shutoff control circuit.

Processing pertaining to [EXTRACT TARGET TO WHICH POWER-SHUTOFF INTEGRATED CIRCUIT IS TO BE CONNECTED] step 804 is performed by the power shutoff connection analysis section 904b, and an integrated circuit (a connection-target integrated circuit) connected to the integrated circuits whose power is to be shut off is extracted. Information about the connection-target integrated circuit is stored.

Processing pertaining to [INSERT POWER SHUTOFF CONTROL CIRCUIT] step 805 is performed by the power shutoff control circuit insertion section 904c. A power shutoff control circuit is inserted according to the pattern of a power shutoff state selected in step 803, and the net list is changed.

Processing pertaining to [CREATE POWER SHUTOFF CONTROL CIRCUIT IN TOTAL POWER SHUTOFF STATE] step 806 is performed by the power shutoff control circuit insertion section 904c. Information about a sequence of integrated circuits being subjected to power shutoff stored in step 801 is compared with the patterns of the power shutoff state by means of power shutoff control circuit insertion processing is performed in step 803. When power shutoff control circuit insertion processing is not performed in the pattern of total power shutoff state, processing returns to step 803. When power shutoff control circuit insertion processing has been performed in the pattern of total power shutoff state, processing proceeds to the next step.

Processing pertaining to [SEQUENTIALLY PERFORM PROCESSING OF INTEGRATED CIRCUIT FIRST SUBJECTED TO POWER SHUTOFF] step 807 is performed by the terminal analysis section 904d. Integrated circuits to be subjected to power shutoff are sequentially selected in accordance with the information about a sequence of integrated circuits being subjected to power shutoff stored in step 801, and insertion of a power shutoff circuit is prepared.

Processing pertaining to [EXTRACT ALL TERMINALS OF POWER-SHUTOFF INTEGRATED CIRCUIT] step 808 is performed by the terminal analysis section 904d. In accordance with the integrated circuit information stored in step 801, input/output terminals of the integrated circuit selected in step 807 are extracted from the net list, and information about the terminals is stored.

Processing pertaining to [PERFORM PROCESSING OF ONE OF UNVERIFIED TERMINALS OF POWER-SHUTOFF CIRCUIT] step 809 is performed by the circuit data alteration section 904. In accordance with the all terminal information stored in step 808 and the expected output value information about the power shutoff circuit stored in step 801, one terminal which has not yet been subjected to power shutoff circuit insertion processing is selected in connection with the selected integrated circuit. The thus-selected terminal is registered as an object of power shutoff circuit insertion processing.

Processing pertaining to [CHECK INPUT-AND-OUTPUT ATTRIBUTE OF TERMINAL] step 810 is performed by the circuit data alteration section 904e. In relation to the terminal registered as an object of power shutoff circuit insertion processing in step 809, the configuration of a connection between the selected integrated circuit and the connection-target integrated circuit is retrieved, to thus ascertain whether the registered terminal is an input terminal or an output terminal.

Processing pertaining to [INSERT POWER SHUTOFF CIRCUIT] step 811 is performed by the circuit data alteration section 904e. In accordance with the expected output value of the power shutoff circuit stored in step 801 and the expected value of the power shutoff control signal generated by the power shutoff control circuit, an appropriate power shutoff circuit is selected and inserted.

Processing pertaining to [RECONNECT SIGNAL LINES] step 812 is performed by the circuit data alteration section 904e. A connection to each of the input and output terminals of the power shutoff circuit inserted in step 811 is made, and the net list is altered.

Processing pertaining to [CONNECT POWER SHUTOFF CONTROL SIGNAL] step 813 is performed by means of the circuit data alteration section 904e. The power shutoff control signal of the power shutoff circuit inserted in step 811 is connected, and the net list is altered.

Processing pertaining to [CONNECT POWER] step 814 is performed by the circuit data alteration section 904e. The power shutoff circuit inserted in step 811 is generated in an integrated circuit which becomes later in power shutoff sequence than the selected integrated circuit or in the integrated circuit whose power is not shut off, and the net list is altered.

Processing pertaining to [CONNECT ALL TERMINALS OF POWER SHUTOFF CIRCUIT] step 815 is performed by the circuit data alteration section 904e. Information about all terminals of the selected integrated circuit extracted in step 808 is compared with the terminal having undergone power shutoff circuit insertion. When all of the terminals of the selected integrated circuit are not subjected to power shutoff circuit insertion processing, processing returns to step 809. When all terminals of the selected integrated circuit have undergone power shutoff circuit insertion processing, processing proceeds to the next step.

Processing pertaining to [CONNECT ALL TERMINALS OF POWER SHUTOFF CIRCUIT WHOSE POWER IS TOTALLY SHUT OFF] step 816 is performed by the circuit data alteration section 904e. The information about the sequence of the integrated circuits being subjected to power shutoff stored in step 801 is compared with the pattern of power shutoff state acquired as a result of power shutoff control circuit insertion processing pertaining to step 803 having been performed. When all of the terminals of the integrated circuit whose power is shut off in a totally power shutoff state are not subjected to power shutoff circuit insertion processing, processing returns to step 807. When all of the terminals of the integrated circuit whose power is shut off in a totally power shutoff state have undergone power shutoff circuit insertion processing, processing proceeds to the next step.

When all of the terminals of the integrated circuit whose power is shutoff in a totally power shutoff state have undergone power shutoff circuit insertion processing, there is output a net list into which the power shutoff control circuit and the power shutoff circuit are inserted in the [OUTPUT NET LIST INTO WHICH POWER SHUTOFF CONTROL CIRCUIT AND POWER SHUTOFF CIRCUIT ARE INSERTED] step 817.

Processing pertaining to [OUTPUT REPORT] step 818 is performed by the output section 904f. Information about the type of the power shutoff circuit inserted into the input net list, the type of the power shutoff control circuit inserted into the same, the locations where the power shutoff circuit and the power shutoff control circuit are inserted, and connections among altered or added lines is output as a report file.

By means of the above-described power shutoff control circuit insertion method, even when a plurality of integrated circuits constituting an LSI are supplied with three or more of power sources and have a plurality of power shutoff states, there can be inserted a power shutoff circuit which prevents occurrence of a leakage current in a signal between integrated circuits in every power shutoff state and a power shutoff control circuit for controlling the power shutoff circuit. Locations where the power shutoff circuit and the power shutoff control circuit are inserted can be ascertained by the report file.

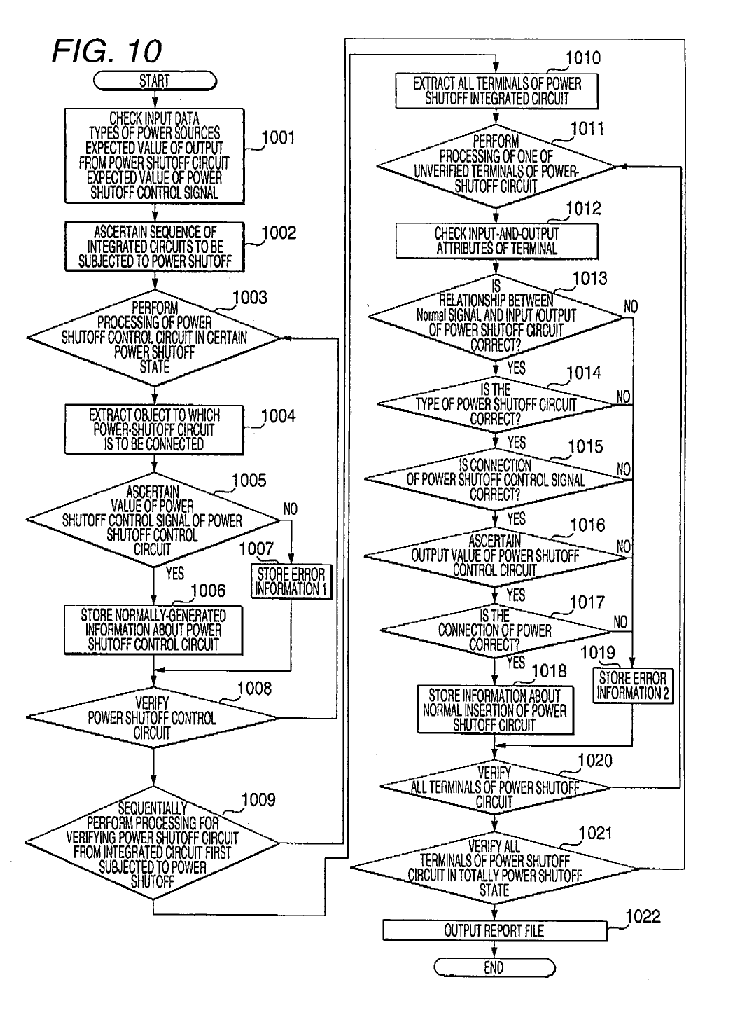

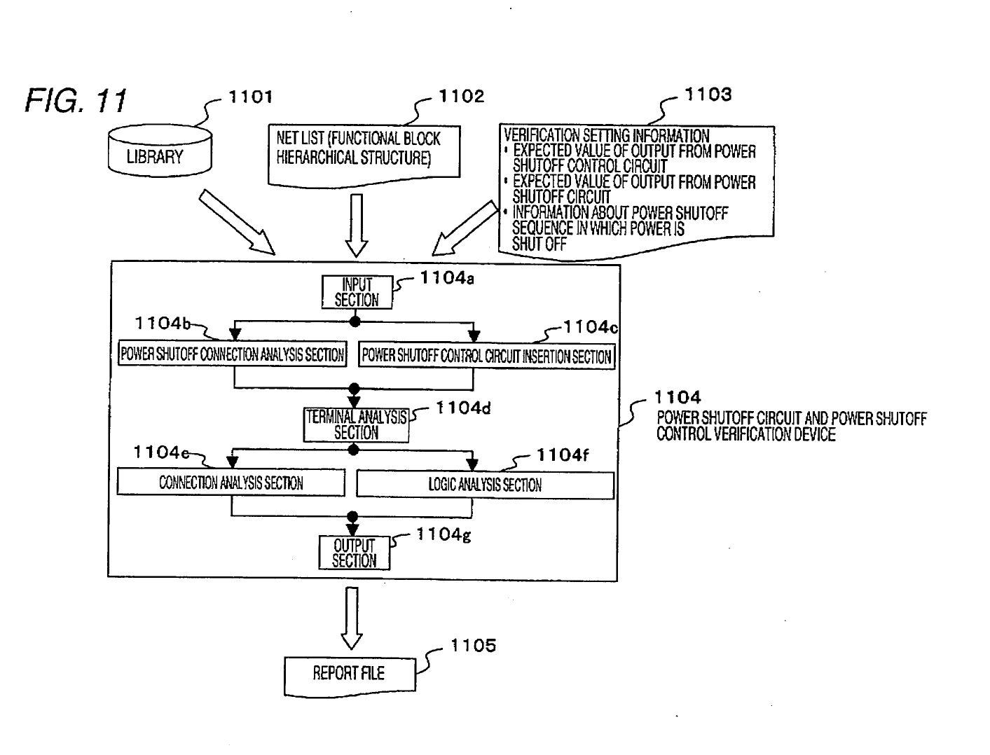

Next will be described verification procedures of the power shutoff control circuit insertion method. FIG. 10 is a flowchart showing verification procedures of the power shutoff control circuit insertion method. FIG. 11 is a block diagram showing the general configuration of a power shutoff control circuit verification device—which implements verification procedures of the power shutoff control circuit insertion method—and information about inputs and outputs to and from the power shutoff control circuit verification apparatus.

In FIG. 11, reference numeral 1104 designates a power shutoff control circuit verification device. Reference numeral 1101 designates a library including circuit configuration data pertaining to a power shutoff circuit; 1102 designates a net list having a functional block hierarchical structure; and 1103 designates verification setting information, and they are taken as information input to the power shutoff control circuit verification device.

The verification setting information 1103 includes power shutoff sequence information about an integrated circuit to be subjected to power shutoff, integrated circuit information to be subjected to power shutoff, information about terminals of the integrated circuit; information about an integrated circuit to which connection is to be made; an expected value of an output from the power shutoff circuit during power shutoff; and an expected value of a power shutoff control signal generated by the power shutoff control circuit.

As a result of these pieces of input information being input to the power shutoff control circuit verification device 1104, a check is made as to whether or not the power shutoff circuit and the power shutoff control circuit are properly inserted, and a report file 1105 having a description of a check result is output.

In the power shutoff control circuit verification device 1104, reference numeral 1104a designates an input section for inputting and storing the library 1101, the net list 1102, and the verification setting information 1103; 1104b designates a power shutoff connection analysis section for extracting and storing information about an integrated circuit whose power is to be shut off and a connection target integrated circuit; 1104c designates a power shutoff control circuit analysis section for inserting the power shutoff control circuits such as those indicated by the first through eighth example configurations; 1104d designates a terminal analysis section for analyzing input/output attributes of terminals of the integrated circuit whose power is to be shut off and input/output attributes of terminals of the connection target integrated circuit; 1104e designates a connection analysis section which wires terminals by means of inserting the power shutoff circuit such as that shown in FIG. 7 into the signal line—to which the integrated circuit is to be connected—and which analyzes whether or not a connection is made to the power shutoff control signal generated by the power shutoff control circuit; 1104f designates a logic analysis section for analyzing whether or not the connection is defective; and 1104g designates an output section for outputting the report file 1105 having the description of the analysis result.

Verification procedures of the method for verifying the power shutoff circuit and verification procedures thereof—which are implemented by the power shutoff control circuit verification device 1104—will now be described by reference to the flowchart shown in FIG. 10.

Processing pertaining to [CHECK INPUT DATA] step 1001 is performed by the input section 1104a. There are input types of power supplied to the respective integrated circuits, information about a sequence of integrated circuits undergoing power shutoff, verification setting information about an expected value of an output from a power shutoff circuit to be inserted and an expected value of a power shutoff control signal generated by the power shutoff control circuit, and a net list and a library of each of the integrated circuits. An inspection is made as to whether or not the sets of data have a data configuration which poses no problem in processing for inserting the power shutoff circuit and the power shutoff control circuit. These sets of data are stored.

Processing pertaining to [CHECK SEQUENCE OF INTEGRATED CIRCUITS BEING SUBJECTED TO POWER SHUTOFF] step 1002 is performed by the input section 1104a. Patterns of a power shutoff state are registered on the basis of information about a sequence of integrated circuits stored in step 1001 being subjected to power shutoff.

Processing pertaining to [PERFORM PROCESSING OF CERTAIN POWER SHUTOFF CONTROL CIRCUIT IN POWER SHUTOFF STATE] step 1003 is performed by the power shutoff connection analysis section 1104b. The patterns of the power shutoff state registered in step 1002 are sequentially selected, to thus prepare for verification of a power shutoff control circuit.

Processing pertaining to [EXTRACT TARGET TO WHICH POWER-SHUTOFF INTEGRATED CIRCUIT IS TO BE CONNECTED] step 1004 is performed by the power shutoff connection analysis section 1104b, and an integrated circuit connected to the integrated circuits whose power is to be shut off is extracted. Information about the connection-target integrated circuit is stored.

Processing pertaining to [ASCERTAIN VALUE OF POWER SHUTOFF CONTROL SIGNAL OF POWER SHUTOFF CONTROL CIRCUIT] step 1005 is performed by a power shutoff control circuit analysis section 1104c, thereby ascertaining the type of the inserted power shutoff control circuit. An output value of the power shutoff control signal and an expected value of the power shutoff control signal stored in step 1001 are compared with each other. When a coincidence exists between the values, processing proceeds to [STORE NORMALLY-GENERATED INFORMATION ABOUT POWER SHUTOFF CONTROL CIRCUIT] step 1006, where result information is stored. When coincidence does not exist, processing proceeds to [STORE ERROR INFORMATION 1] step 1007, where error information is stored.

Processing pertaining to [VERIFY POWER SHUTOFF CONTROL CIRCUIT] step 1008 is performed by the power shutoff control circuit analysis section 1104c. When all patterns of power shutoff state have been subjected to verification processing pertaining to steps 1004 to 1007, processing proceeds to the next step. When not all patterns have been subjected to verification processing, processing returns to step 1003.

Processing pertaining to [SEQUENTIALLY PERFORM PROCESSING FOR VERIFYING POWER SHUTOFF CIRCUIT FROM INTEGRATED CIRCUIT FIRST SUBJECTED TO POWER SHUTOFF] step 1009 is performed by the terminal analysis section 1104d. Integrated circuits to be subjected to power shutoff are sequentially selected in accordance with the information about a sequence of power shutoff circuits stored in step 1001 being subjected to power shutoff, and verification of the power shutoff circuit is prepared.

Processing pertaining to [EXTRACT ALL TERMINALS OF POWER SHUTOFF INTEGRATED CIRCUIT] step 1010 is performed by the terminal analysis section 1104d. In accordance with the integrated circuit information stored in step 1001, input/output terminals of the integrated circuit selected in step 1007 are extracted from the net list, and information about the terminals is stored.

Processing pertaining to [PERFORM PROCESSING OF ONE OF UNVERIFIED TERMINALS OF POWER-SHUTOFF CIRCUIT] step 1011 is performed by the connection analysis section 1104e. In accordance with all terminal information about the selected integrated circuit extracted in step 1010, one terminal which has not yet been subjected to verification processing is selected. The thus-selected terminal is registered as an object of power shutoff circuit verification processing.

Processing pertaining to [CHECK INPUT-AND-OUTPUT ATTRIBUTES OF TERMINAL] step 1012 is performed by the connection analysis section 1104e. In relation to the terminal registered as an object of power shutoff circuit verification processing in step 809, the configuration of a connection between the selected integrated circuit and the connection-target integrated circuit is retrieved, to thus ascertain whether the registered terminal is an input terminal or an output terminal.

Processing pertaining to [IS RELATIONSHIP BETWEEN Normal SIGNAL AND INPUT/OUTPUT OF POWER SHUTOFF CIRCUIT CORRECT?] step 1013 is performed by the connection analysis section 1104e. A power shutoff circuit is retrieved by means of the connection configuration retrieved in step 1012. A check is made as to whether or not an input terminal is connected to an output terminal of an integrated circuit and an output terminal is connected to an input terminal of the integrated circuit in accordance with the direction of insertion of the retrieved power shutoff circuit. When the connection is wrong, processing proceeds to [STORE ERROR INFORMATION 2] step 1019. When the connection is normal, processing proceeds to [IS THE TYPE OF POWER SHUTOFF CIRCUIT CORRECT?] step 1014.

Processing pertaining to [IS THE TYPE OF POWER SHUTOFF CIRCUIT CORRECT?] step 1014 is performed by means of the logic analysis section 1104f. A check is made as to whether or not a power shutoff circuit of appropriate type is used, in accordance with input-and-output attributes of the terminals verified in step 1012. When the type of the power shutoff circuit is wrong, processing proceeds to [STORE ERROR INFORMATION 2] step 1019. When the type of the power shutoff circuit is normal, processing proceeds to [IS CONNECTION OF POWER SHUTOFF CONTROL SIGNAL CORRECT?] step 1015.

Processing pertaining to [IS CONNECTION OF POWER SHUTOFF CONTROL SIGNAL CORRECT?] step 1015 is performed by the connection analysis section 1104e. It is ascertained that the power shutoff control signal stored in step 1006 is connected to the power shutoff control signal of the power shutoff circuit checked in step 1014. When the connection is wrong, processing proceeds to [STORE ERROR INFORMATION 2] step 1109. When the connection is correct, processing proceeds to [ASCERTAIN OUTPUT VALUE OF POWER SHUTOFF CONTROL CIRCUIT] step 1016, Processing pertaining to [ASCERTAIN OUTPUT VALUE OF POWER SHUTOFF CONTROL CIRCUIT] step 1016 is performed by the logic analysis section 1104f, where a check is made, from the logic acquired during power shutoff described in verification setting information 1103, as to whether or not the power shutoff circuit enters a power shutoff mode. When the logic acquired as a result of power shutoff is wrong, processing proceeds to [STORE ERROR INFORMATION 2] step 1109. When the logic acquired as a result of power shutoff is normal, processing proceeds to [IS THE CORRECTION OF POWER CORRECT?] step 1017.

Processing pertaining to [IS CONNECTION OF POWER CORRECT?] step 1017 is performed by the connection analysis section 1104e. Power of the power shutoff circuit is verified to be connected to the same power as that of the integrated circuit subjected to power shutoff later in sequence as compared with the integrated circuit for which power of the power shutoff circuit has been selected or that of the integrated circuit whose power is not shut off. When the connection relationship of power is wrong, processing proceeds to [STORE ERROR INFORMATION 2] step 1019. When power is connected properly, processing proceeds to [STORE INFORMATION ABOUT NORMAL INSERTION OF POWER SHUTOFF CIRCUIT] step 1018.

Processing pertaining to [STORE INFORMATION ABOUT NORMAL INSERTION OF POWER SHUTOFF CIRCUIT] step 1018 is performed by means of the logic analysis section 1104f. As a result of verification, the type of the power shutoff circuit inserted into terminals of the selected integrated circuit and information about the connection of the power shutoff circuit are stored.

In [STORE ERROR INFORMATION 2] step 1019, a process where an error has arisen or an error code is stored.

In [VERIFY ALL TERMINALS OF POWER SHUTOFF CIRCUIT] step 1020, information about all terminals of the integrated circuit extracted and selected in step 1010 is compared with the terminals having undergone power shutoff circuit verification. When not all of the terminals have undergone power shutoff circuit verification processing, processing returns to [PERFORM PROCESSING OF ONE OF UNVERIFIED TERMINALS OF POWER SHUTOFF CIRCUIT] step 1011. When all of the terminal shave undergone power shutoff circuit verification processing, processing proceeds to the next step.

Processing pertaining to [VERIFY ALL TERMINALS OF POWER SHUTOFF CIRCUIT IN TOTALLY POWER SHUTOFF STATE] step 1021 is performed by means of the logic analysis section 1104f. Information about the sequence of integrated circuits being subjected to power shutoff stored in step 1001 is compared with the pattern of the power shutoff state acquired as a result of performance of power shutoff circuit verification processing in step 1009. When not all of the terminals of the integrated circuit whose power is shutoff in a totally power shutoff state have undergone power shutoff circuit verification processing, processing returns to step 1009. When all of the terminals of the integrated circuit whose power is to be shutoff have undergone power shutoff circuit verification processing, processing proceeds to the next step.

Processing pertaining to [OUTPUT REPORT FILE] step 1022 is performed by the output section 1104g. Information about [STORE INFORMATION ABOUT NORMAL INSERTION OF POWER SHUTOFF CIRCUIT] step 1018 and information about [STORE ERROR INFORMATION 2] step 1019 are saved as a file, and a report file is output.

By means of the power shutoff control circuit insertion method mentioned in detail above, there can be properly performed verification of normal insertion of a power shutoff control signal generated by the power shutoff control circuit, verification of normal insertion of the power shutoff circuit that prevents occurrence of a leakage current in a signal between integrated circuits, and verification of normal operation performed in a normal mode and a power shutoff mode.

The integrated circuit apparatus of the present invention enables generation and verification of a power shutoff circuit and a power shutoff control circuit so that generation of a leakage current can be prevented in all power shutoff states; and is useful for reducing the amount of power consumed by a semiconductor integrated circuit of multi-power specifications.

What is claimed is:

1. An integrated circuit apparatus made up of three or more integrated circuits which are supplied with power from three or more power supply sources that can be subjected to individually-controllable shutoff and which are sequentially subjected to interruption of power supply, the apparatus comprising:
a power shutoff circuit inserted into a signal line for connecting the integrated circuits at a position close to an integrated circuit which becomes later in sequence of undergoing power shutoff as compared with the integrated circuits selected in sequence in which power supply is interrupted or at a position close to an integrated circuit whose power is not shutoff; and
a power shutoff control circuit which imparts a power shutoff control signal to the power shutoff circuit such that an output from the power shutoff circuit is controlled so as to enter a fixed state at the time of shutoff of power of the target connection integrated circuit, wherein the power shutoff control circuit is formed in a dispersed manner at a position close to the integrated circuit which becomes later in sequence of being subjected to power shutoff as compared with the integrated circuits selected in sequence in which power supply is interrupted or at a position close to an integrated circuit whose power is not shut off.

2. The integrated circuit apparatus according to claim 1, wherein the power shutoff control circuit is formed on an integrated circuit into which the power shutoff circuit is inserted.

3. The integrated circuit apparatus according to claim 1, wherein the power shutoff control circuit is formed on the integrated circuit whose power is not shut off, and the power shutoff control signal is imparted to the power shutoff circuit via the integrated circuit into which the power shutoff circuit is inserted.

4. The integrated circuit apparatus according to claim 1, wherein the power supply source is formed from one external supply source and a plurality of internally-provided power switches.
